(19) United States
(12) Patent Application Publication
(10) Pub. No.: US 2012/0002044 A1
(43) Pub. Date: Jan. 5, 2012

(54) Method and System for Implementing a Three-Dimension Positioning

(75) Inventors: Jiangwei Li, Guangdong (CN); Jie Liang, Guangdong (CN); Ming Feng, Beijing (CN); Ruyi Li, Beijing (CN); Xueliang Chen, Guangdong (CN); Yirong Zhuang, Guangdong (CN); Ge Chen, Guangdong (CN); Xiaomei Han, Guangdong (CN); Jinxia Hai, Guangdong (CN)

(73) Assignee: China Telecom Corporation Limited, Beijing (CN)

(21) Appl. No.: 12/974,373

(22) Filed: Dec. 21, 2010

(30) Foreign Application Priority Data
Jan. 4, 2010 (CN) 201010000032.3

(51) Int. Cl. H04N 7/18; G06K 9/00

(52) U.S. Cl. 348/142; 382/154; 348/E07.085

(57) ABSTRACT

The present invention discloses a method and system for implementing a three-dimension positioning. The method comprises: receiving, by an optical sensor, infrared rays emitted from an infrared reference light source; and determining a position of the optical sensor with respect to the infrared reference light source based on attributes of the infrared reference light source in images obtained by the optical sensor, so as to implement a three-dimension relative positioning of the optical sensor. The method and system determine the position of the optical sensor with respect to the infrared reference light source by means of the attributes of the infrared reference light source in the images, which are simple in implementation, of a relatively low cost and can provide an excellent positioning function for application contexts of relative positioning (such as immersive video), which greatly improves the experience of a user.

### BACKGROUND OF THE INVENTION

1. Field of the Invention

The present invention relates to a technical field of immersive video, and more specifically, to a method and system for implementing a three-dimension positioning.

2. Description of the Related Art

In recent years, the positioning technologies have been developed rapidly, but most of them are out-door positioning technologies. For example, an in-vehicle Global Position System (GPS) is a system for positioning and navigating with respect to an outside environment, and applying this system indoors can not present an indoor environment.

An indoor positioning technology is currently not a relatively developed technology due to the restrictions such as positioning time, positioning precision, indoor complicated environment and other conditions. Accordingly, experts have proposed a lot of solutions for indoor positioning technologies, such as A-GPS (Assisted GPS) positioning technology, ultrasonic positioning technology, Bluetooth technology, infrared technology, radio-frequency identification technology, Ultra-Wide-Band technology, wireless local area network technology, light tracing positioning technology, image analysis, beacon positioning, computer vision positioning technology and so on. Generally, these indoor positioning technologies can be classified into the following categories: Global Navigation Satellite Systems (GNSS) (such as Pseudo-Satellite and so on), wireless positioning technologies (such as wireless communication signals, radio-frequency wireless tag, ultrasonic wave, light tracing, wireless sensor positioning technology and so on), other positioning technologies (such as computer vision, “dead reckoning” and so on) and positioning technologies of the combination of the GNSS and wireless positioning technologies (such as A-GPS or A-GNSS (Assisted GNSS)).

The above positioning technologies are all complicated and costly, and are not suitable to all the application fields. In some application fields (such as an immersive video field), an absolute positioning precision is not required and thus, how to obtain an three-dimension space relative positioning method that is easy to be implemented and has a relatively low cost is an incoming problem at present.

### SUMMARY OF THE INVENTION

A technical problem to be solved by the present invention is to provide a method for implementing a three-dimension positioning capable of easily implementing a relative positioning for a three-dimension space with low cost.

The present invention provides a method for implementing a three-dimension positioning, the method comprising: receiving, by an optical sensor, infrared rays emitted from an infrared reference light source; and determining a position of the optical sensor with respect to the infrared reference light source based on attributes of the infrared reference light source in images obtained by the optical sensor, so as to implement a three-dimension relative positioning of the optical sensor.

According to an embodiment of the method of the present invention, the attributes of the infrared reference light source include an orientation of the infrared reference light source and the number of pixel points of the infrared reference light source.

According to another embodiment of the method of the present invention, the step of determining a position of the optical sensor with respect to the infrared reference light source based on attributes of the infrared reference light source in images obtained by the optical sensor comprises: determining an orientation of the optical sensor with respect to the infrared reference light source based on orientations of the infrared reference light source in the images.

According to a further embodiment of the method of the present invention, the step of determining a position of the optical sensor with respect to the infrared reference light source based on attributes of the infrared reference light source in images obtained by the optical sensor comprises: determining a distance of the optical sensor with respect to the infrared reference light source based on the number of pixel points of the infrared reference light source in the images.

According to a still further embodiment of the method of the present invention, the orientations of the infrared reference light source in the images are: an upper portion, a lower portion, a left portion and a right portion of the images where the infrared reference light source lies; and the step of determining an orientation of the optical sensor with respect to the infrared reference light source based on orientations of the infrared reference light source in images comprises: determining, based on the orientation of the infrared reference light source in the images, that the optical sensor is moving with respect to the infrared reference light source in a direction opposite to the orientations of the infrared reference light source in the images.

According to a still further embodiment of the method of the present invention, the step of determining a distance of the optical sensor with respect to the infrared reference light source based on the number of pixel points of the infrared reference light source in the images comprises: determining, based on an increase or decrease of the number of pixel points of the infrared reference light source in the images, whether the optical sensor comes close to the infrared reference light source or goes away from the infrared reference light source.

According to a still further embodiment of the method of the present invention, before receiving, by the optical sensor, the infrared rays emitted from the infrared reference light source, the method further comprises: filtering rays incident on the optical sensor by a light filter, so as to let the infrared rays enter into the optical sensor.

The method for implementing a three-dimension positioning provided by the present invention, which determines the position of the optical sensor with respect to the infrared reference light source by means of the attributes of the infrared reference light source in the images, is not only simple in implementation, but also of a relatively low cost in comparison with the prior art, and the method can provide an excellent positioning function for application contexts of relative positioning (such as immersive video), which greatly improves the experience of a user.

Another technical problem to be solved by the present invention is to provide a system for implementing a three-dimension positioning capable of easily implementing a relative positioning for a three-dimension space with low cost.

The present invention further provides a system for implementing a three-dimension positioning, the system comprising: an image receiving module for receiving infrared rays from an infrared reference light source and obtained by an optical sensor; and an image processing module for determining a position of the optical sensor with respect to the infrared reference light source based on attributes of the infrared reference light source in images received by the image receiving module, so as to implement a three-dimension relative positioning of the optical sensor.

According to an embodiment of the system of the present invention, the attributes of the infrared reference light source include an orientation of the infrared reference light source and the number of pixel points of the infrared reference light source.

According to another embodiment of the system of the present invention, the image processing module comprises: an orientation determining unit for determining an orientation of the optical sensor with respect to the infrared reference light source based on orientations of the infrared reference light source in the images; and a distance determining unit for determining a distance of the optical sensor with respect to the infrared reference light source based on the number of pixel points of the infrared reference light source in the images.

According to a still further embodiment of the system of the present invention, the optical sensor is covered with a light filter.

According to a still further embodiment of the system of the present invention, the optical sensor is provided opposite to the infrared reference light source.

The system for implementing a three-dimension positioning provided by the present invention, which determines the position of the optical sensor with respect to the infrared reference light source by means of the attributes of the infrared reference light source in the images, is not only simple in implementation, but also of a relatively low cost in comparison with the prior art, and the system can provide an excellent positioning function for application contexts of relative positioning (such as immersive video), which greatly improves the experience of a user.

### BRIEF DESCRIPTION OF THE DRAWINGS

The accompanying drawings illustrated here, which constitute a part of the specification, serve to provide a further explanation of the present invention. In the drawings:

FIG. 1 is a schematic flowchart of an embodiment of the method of the present invention;

FIG. 2 is a schematic diagram of an application context of the present invention;

FIG. 3 is a schematic flowchart of another embodiment of the method of the present invention;

FIG. 4 is a schematic structure diagram of an embodiment of the system of the present invention; and

FIG. 5 is a schematic structure diagram of another embodiment of the system of the present invention.

### DESCRIPTION OF THE EMBODIMENTS

The present invention will be described in more complete way below with reference to the drawings, wherein the illustrative embodiments of the present invention are illustrated. The illustrative embodiments and the descriptions thereof are for illustrating the present invention, and are not an appropriate limitation to the present invention.

At present, the theory of the infrared positioning technology is that modulated infrared rays are emitted by an infrared IR identifier and received by an optical sensor mounted indoors so as to perform positioning. Although the infrared rays have a relatively high degree of indoor positioning accuracy, the infrared rays can just be propagated by line-of-sight since a light ray can not penetrate through an obstacle. The infrared positioning has a worse effect due to the two main disadvantages of straight-line-of-sight and a shorter propagation distance. When the infrared IR identifier is placed in pockets or sheltered by an obstacle such as a wall and so on, this positioning method can not work properly, and at this time, it is necessary to mount receiving antennas in every room and corridor so that the cost is relatively high. Therefore, infrared positioning technologies are only suitable for short-distance propagation, and are prone to be interfered by fluorescent lamps or other light in the room, so that they have limitations in accurate positioning.

The present invention proposes a method and system for implementing a three-dimension positioning irrespective of obstacles and in combination of the above infrared positioning theory, and the method and system can be suitable for certain application contexts of relative positioning, such as Immersive Video, Immersive Game, Virtue Reality, Human-Computer Interaction or Home Entertainment and so on. These three-dimension applications are generally performed within the valid range of one room, and thus the characteristics of infrared rays can be effectively used.

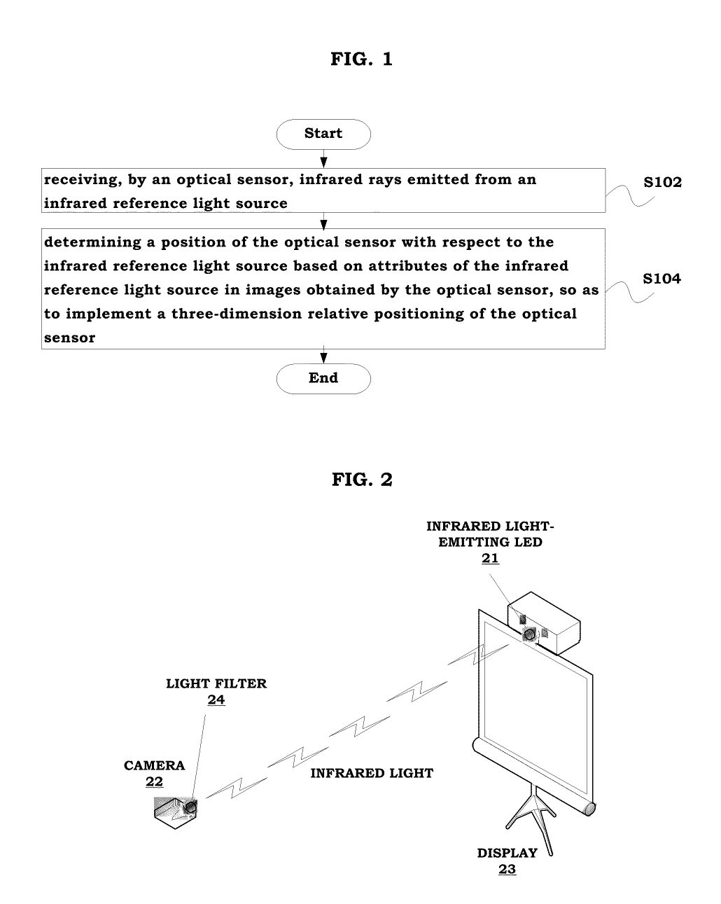

FIG. 1 is a schematic flowchart of an embodiment of the method of the present invention.

As shown in FIG. 1, this embodiment can comprises the following steps:

S102, an optical sensor receives infrared rays emitted from an infrared reference light source, wherein the infrared reference light source can be any light-emitting device that can emit infrared light, such as an infrared light-emitting LED; and

S104, a position of the optical sensor with respect to the infrared reference light source is determined based on attributes of the infrared reference light source in images obtained by the optical sensor, so as to implement a three-dimension relative positioning of the optical sensor. For example, the attributes of the infrared reference light source can include an orientation of the infrared reference light source and the number of pixel points of the infrared reference light source.

In this embodiment, the optical sensor can be mounted on an movement device such as a handle, and when the movement device moves with respect to the infrared reference light source, the movement direction of the movement device with respect to the infrared reference light source can be detected in real time through the images obtained by the optical sensor during moving, so as to implement a three-dimension relative positioning in an easy way.

In another embodiment of the method of the present invention, the step of determining a position of the optical sensor with respect to the infrared reference light source based on attributes of the infrared reference light source in images obtained by the optical sensor can comprise: determining an orientation of the optical sensor with respect to the infrared reference light source based on orientations of the infrared reference light source in the images.

For example, it can be determined, based on the orientations of the infrared reference light source in the images, that the optical sensor is moving with respect to the infrared reference light source in a direction opposite to the orientations of the infrared reference light source in the images, wherein, the orientations of the infrared reference light source in the images can be: an upper portion, a lower portion, a left portion and a right portion of the images where the infrared reference light source lies.

In an embodiment, when a movement device mounted with an optical sensor moves leftward and rightward in the horizontal plane, the movement direction of the movement device with respect to the infrared reference light source can be judged based on the number of the light source points obtained from respective areas of the images. If the number of the light source points in the right areas of the images increase, it can be determined that the movement device is moving leftward with respect to the infrared reference light source. If the number of the light source points in the left areas of the images increase, it can be determined that the movement device is moving rightward with respect to the infrared reference light source. When a movement device mounted with an optical sensor moves upward and downward, the movement direction of the movement device with respect to the infrared reference light source can also be judged based on the number of the light source points obtained from respective areas of the images. If the number of the light source points in the lower areas of the images increase, it can be determined that the movement device is moving upward with respect to the infrared reference light source. If the number of the light source points in the upper areas of the images increase, it can be determined that the movement device is moving downward with respect to the infrared reference light source.

In another embodiment, the movement of the movement device with respect to the infrared reference light source can also be judged based on the specific location of the light source. When the infrared reference light source obtained in the images is gradually moving toward the left areas of the images, it is indicated that the movement device is moving rightward with respect to the infrared reference light source. When the infrared reference light source obtained in the images is gradually moving toward the right areas of the images, it is indicated that the movement device is moving leftward with respect to the infrared reference light source. When the infrared reference light source obtained in the images is gradually moving toward the upper areas of the images, it is indicated that the movement device is moving downward with respect to the infrared reference light source. When the infrared reference light source obtained in the images is gradually moving toward the lower areas of the images, it is indicated that the movement device is moving upward with respect to the infrared reference light source.

By means of this embodiment, the upward, downward, leftward and rightward movement trend of the movement device with respect to the infrared reference light source can easily be determined based on the number of the light source points in each of the areas of the images.

In a further embodiment of the method of the present invention, the step of determining a position of the optical sensor with respect to the infrared reference light source based on attributes of the infrared reference light source in images obtained by the optical sensor comprises: determining a distance of the optical sensor with respect to the infrared reference light source based on the number of pixel points of the infrared reference light source in the images.

For example, it can be determined, based on an increase or decrease of the number of pixel points of the infrared reference light source in the images, whether the optical sensor comes close to the infrared reference light source or goes away from the infrared reference light source. When the number of pixel points of the infrared reference light source in the images increases, it is indicated that the movement device gradually comes close to the infrared reference light source. When the number of pixel points of the infrared reference light source in the images decreases, it is indicated that the movement device gradually goes away from the infrared reference light source.

Alternatively, the position of the movement device with respect to the infrared reference light source can also be judged based on the size and brightness of the display of the infrared reference light source in the images. When the infrared reference light source obtained in the images is getting larger and the light source is getting brighter, it is indicated that the movement device gradually comes close to the infrared reference light source. When the infrared reference light source obtained in the images is getting smaller and the light source is getting darker, it is indicated that the movement device gradually goes away from the infrared reference light source.

By means of this embodiment, the forward and backward movement trend of the movement device with respect to the infrared reference light source can easily be determined based on the number of the light source points in each of the areas of the images.

In a still further embodiment of the method of the present invention, before the optical sensor receives the infrared rays emitted from the infrared reference light source, rays incident on the optical sensor are further filtered by a light filter, so as to let infrared rays enter into the optical sensor. As such, it can be guaranteed that only the infrared rays can enter into the optical sensor via the light filter, which significantly decreases the interference of other light rays with the infrared rays, so that the accuracy of relative positioning can be improved.

FIG. 2 is a schematic diagram of an application context of the present invention.

As shown in FIG. 2, an infrared light-emitting LED 21 is used as the infrared reference light source, and a camera 22 is used as the optical sensor. The infrared light-emitting LED 21 is placed in the direction of a display 23, and the camera is hand-held or is mounted on a handle. The camera 22 is covered with a light filter 24, so as to guarantee that only infrared rays can enter into the camera 22 via the light filter and other rays are all filtered.

When performing Human-Computer Interaction, the handle mounted with the camera moves with respect to the infrared light-emitting LED. The video images captured by the camera are transmitted at a speed of 30 piece/sec., and each of the images is analysed to automatically determine the location and size (i.e. the point number of pixels) of the infrared light-emitting LED in the images and deduce the movement of the handle based on these.

If the infrared light-emitting LED is located at the upper/lower/left/right position of the images, then it can be deduced that the handle mounted with the camera is directed to the lower/upper/right/left position of the screen. The orientation of the light source point of the infrared light-emitting LED can be calculated in a relatively accurate way based on the proportion data of respective orientations of the light source point of the infrared light-emitting LED, and then the screen position pointed to by the handle mounted with the camera can be obtained. If the number of the pixel points of the infrared light-emitting LED in the images is increasing, it can be deduced that the handle mounted with the camera is gradually coming close to the screen, i.e. the infrared light-emitting LED. If the number of the pixel points of the infrared light-emitting LED in the images is decreasing, it can be deduced that the handle mounted with the camera is gradually going away from to the screen, i.e. the infrared light-emitting LED. Thus, the handle mounted with the camera can be accurately positioned with respect to the six orientations of upper, lower, left, right, front and back position of the infrared light-emitting LED through the above process.

In a specific embodiment, the above three-dimension positioning method can adopt an open source OpenCV (Open Source Computer Vision Library) interface and invoke underlying library functions, so that the three-dimension positioning method of the present invention can be carried out in a very easy way, so as to obtain a real-time Human-Computer Interaction.

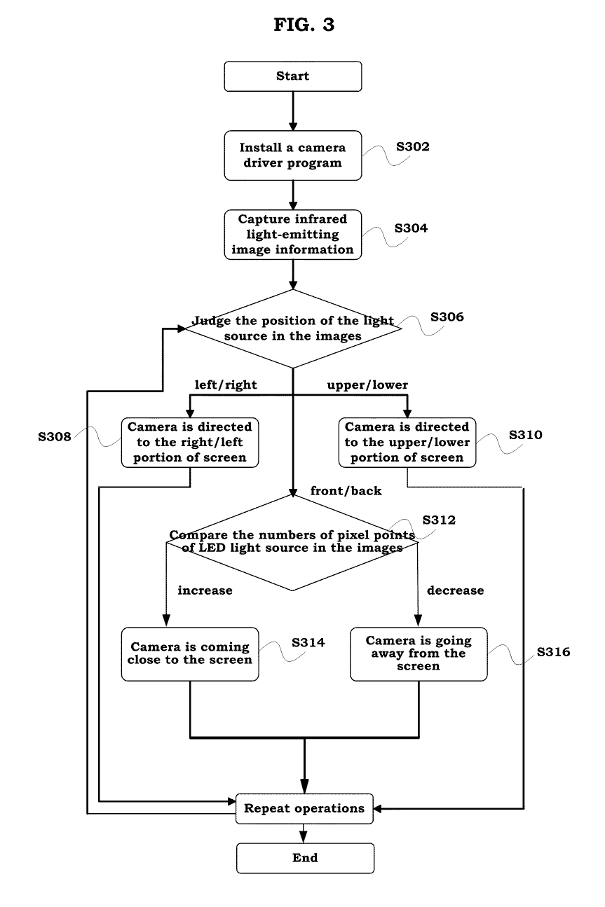

FIG. 3 is a schematic flowchart of another embodiment of the method of the present invention.

As shown in FIG. 3, the embodiment includes the following steps:

S302, installing a camera driver program;

S304, capturing infrared light image information emitted by an infrared light-emitting LED;

S306, determining the position of the infrared light-emitting LED light source in images;

S308, if the LED light source is in the left/right portion of the images, it can be determined that the camera accordingly points to the right/left portion of the screen, i.e. the LED light source;

S310, if the LED light source is in the upper/lower portion of the images, it can be determined that the camera accordingly points to the lower/upper portion of the screen, i.e. the LED light source;

S312, comparing the numbers of the pixel points of the LED light source in the images, so as to determine the front or back orientation of the camera with respect to the infrared light-emitting LED;

S314, if the numbers of the pixel points are more and more, it can be determined that the camera is gradually coming close to the screen;

S316, if the numbers of the pixel points are less and less, it can be determined that the camera is gradually going away from the screen.

The relative position relationship of the upper, lower, left, right, front and back positions of the camera with respect to the infrared light-emitting LED can be accurately deduced through this embodiment.

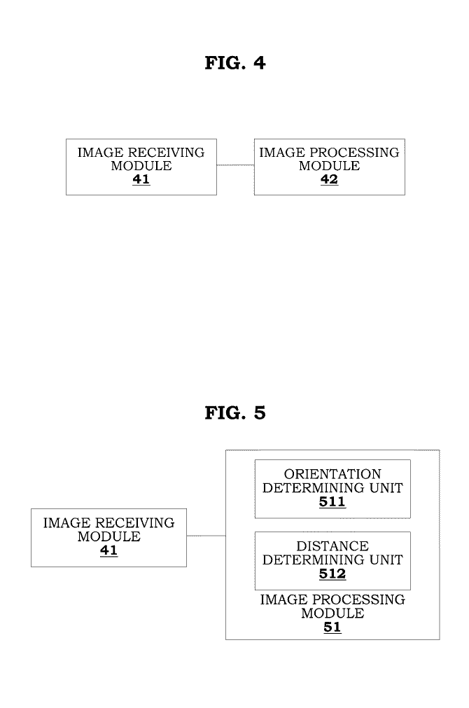

FIG. 4 is a schematic structure diagram of an embodiment of the system of the present invention.

As shown in FIG. 4, the system includes: an image receiving module 41 for receiving infrared rays from an infrared reference light source and obtained by an optical sensor; and an image processing module 42 for determining a position of the optical sensor with respect to the infrared reference light source based on attributes of the infrared reference light source in images received by the image receiving module, so as to implementing a three-dimension relative positioning of the optical sensor.

This embodiment can, in a real-time manner, detect the images obtained by the optical sensor in process of moving, so as to obtain the moving direction of a movement device with respect to the infrared reference light source, thus implementing a three-dimension relative positioning in an easy way.

In another embodiment of the system of the present invention, the attributes of the infrared reference light source include an orientation of the infrared reference light source and the number of pixel points of the infrared reference light source.

FIG. 5 is a schematic structure diagram of another embodiment of the system of the present invention.

As shown in FIG. 5, in comparison with the embodiment of FIG. 4, the image processing module 51 of this embodiment includes: an orientation determining unit 511 for determining an orientation of the optical sensor with respect to the infrared reference light source based on orientations of the infrared reference light source in the images; and a distance determining unit 512 for determining a distance of the optical sensor with respect to the infrared reference light source based on the number of pixel points of the infrared reference light source in the images.

Specifically, the orientation determining unit can determine, based on the orientations of the infrared reference light source in the images, that the optical sensor is moving with respect to the infrared reference light source in a direction opposite to the orientations of the infrared reference light source in the images, wherein the orientations of the infrared reference light source in the images can be: an upper portion, a lower portion, a left portion and a right portion of the images where the infrared reference light source lies.

For example, when a movement device mounted with an optical sensor moves leftward and rightward in the horizontal plane, the movement direction of the movement device with respect to the infrared reference light source can be judged based on the number of the light source points obtained from respective areas of the images. If the number of the light source points in the right areas of the images increase, it can be determined that the movement device is moving leftward with respect to the infrared reference light source. If the number of the light source points in the left areas of the images increase, it can be determined that the movement device is moving rightward with respect to the infrared reference light source. When a movement device mounted with an optical sensor moves upward and downward, the movement direction of the movement device with respect to the infrared reference light source can also be judged based on the number of the light source points obtained from respective areas of the images. If the number of the light source points in the lower areas of the images increase, it can be determined that the movement device is moving upward with respect to the infrared reference light source. If the number of the light source points in the upper areas of the images increase, it can be determined that the movement device is moving downward with respect to the infrared reference light source.

In addition, the distance determining unit 512 can determine, based on an increase or decrease of the number of pixel points of the infrared reference light source in the images, whether the optical sensor comes close to the infrared reference light source or goes away from the infrared reference light source. When the number of pixel points of the infrared reference light source in the images increases, it is indicated that the movement device gradually comes close to the infrared reference light source. When the number of pixel points of the infrared reference light source in the images decreases, it is indicated that the movement device gradually goes away from the infrared reference light source.

The relative position relationship of the upper, lower, left, right, front and back positions of the movement device mounted with the optical sensor with respect to the infrared light-emitting LED can be accurately deduced through this embodiment.

In another embodiment of the present invention, the optical sensor is covered with a light filter. As such, it can be guaranteed that only the infrared rays can enter into the optical sensor via the light filter, which significantly decreases the interference of other light rays with the infrared rays, so that the accuracy of relative positioning can be improved.

In the embodiment of the above system, the optical sensor and the infrared reference light source are set opposite to each other.

The description of the present invention is given with an intention of illustration and description, and is not exhaustive or is not to limit the present invention to the disclosed form. Many modifications and changes can be conceived by a person skilled in the art. The embodiments are selected and described so as to better illustrate the theory and the actual application of the present invention and let a person skilled in the art be able to understand the present invention, so as to design various embodiments with various modification that are suitable for any specific uses.

What is claimed is:

1. A method for implementing a three-dimension positioning, characterized in that, the method comprises:
receiving, by an optical sensor, infrared rays emitted from an infrared reference light source; and
determining a position of the optical sensor with respect to the infrared reference light source based on attributes of the infrared reference light source in images obtained by the optical sensor, so as to implement a three-dimension relative positioning of the optical sensor.

2. The method according to claim 1, characterized in that, the attributes of the infrared reference light source include an orientation of the infrared reference light source and the number of pixel points of the infrared reference light source.

3. The method according to claim 2, characterized in that, the step of determining a position of the optical sensor with respect to the infrared reference light source based on attributes of the infrared reference light source in images obtained by the optical sensor comprises:
determining an orientation of the optical sensor with respect to the infrared reference light source based on orientations of the infrared reference light source in the images.

4. The method according to claim 2, characterized in that, the step of determining a position of the optical sensor with respect to the infrared reference light source based on attributes of the infrared reference light source in images obtained by the optical sensor comprises:
determining a distance of the optical sensor with respect to the infrared reference light source based on the number of pixel points of the infrared reference light source in the images.

5. The method according to claim 3, characterized in that, the orientations of the infrared reference light source in the images are: an upper portion, a lower portion, a left portion and a right portion of the images where the infrared reference light source lies; and
the step of determining an orientation of the optical sensor with respect to the infrared reference light source based on orientations of the infrared reference light source in images comprises:
determining, based on the orientations of the infrared reference light source in the images, that the optical sensor is moving with respect to the infrared reference light source in a direction opposite to the orientations of the infrared reference light source in the images.

6. The method according to claim 4, characterized in that, the step of determining a distance of the optical sensor with respect to the infrared reference light source based on the number of pixel points of the infrared reference light source in the images comprises:
determining, based on an increase or decrease of the number of pixel points of the infrared reference light source in the images, whether the optical sensor comes close to the infrared reference light source or goes away from the infrared reference light source.

7. The method according to claim 1, characterized in that, before receiving, by the optical sensor, the infrared rays emitted from the infrared reference light source, the method further comprises: filtering rays incident on the optical sensor by a light filter, so as to let infrared rays enter into the optical sensor.

8. A system for implementing a three-dimension positioning, characterized in that, the system comprises:
an image receiving module for receiving infrared rays from an infrared reference light source and obtained by an optical sensor; and
an image processing module for determining a position of the optical sensor with respect to the infrared reference light source based on attributes of the infrared reference light source in images received by the mage receiving module, so as to implementing a three-dimension relative positioning of the optical sensor.

9. The system according to claim 8, characterized in that, the attributes of the infrared reference light source include an orientation of the infrared reference light source and the number of pixel points of the infrared reference light source.

10. The system according to claim 9, characterized in that, the image processing module comprises:
an orientation determining unit for determining an orientation of the optical sensor with respect to the infrared reference light source based on orientations of the infrared reference light source in the images; and
a distance determining unit for determining a distance of the optical sensor with respect to the infrared reference light source based on the number of pixel points of the infrared reference light source in the images.

11. The system according to claim 8, characterized in that, the optical sensor is covered with a light filter.

12. The system according to claim 8, characterized in that, the optical sensor is provided opposite to the infrared reference light source.
